(19) United States
(12) Patent Application Publication
(10) Pub. No.: US 2024/0077663 A1
(43) Pub. Date: Mar. 7, 2024

(54) THREE-LAYERED STRUCTURAL COLOR MULTILAYER STRUCTURES

(71) Applicant: Toyota Motor Engineering & Manufacturing North America, Inc., Plano, TX (US)

(72) Inventors: Songtao Wu, Ann Arbor, MI (US); Debasish Banerjee, Ann Arbor, MI (US); Minjuan Zhang, Ann Arbor, MI (US)

(73) Assignees: Toyota Motor Engineering & Manufacturing North America, Inc., Plano, TX (US); Toyota Jidosha Kabushiki Kaisha, Toyota-shi (JP)

(21) Appl. No.: 18/116,601

(22) Filed: Mar. 2, 2023

Related U.S. Application Data
(60) Provisional application No. 63/404,416, filed on Sep. 7, 2022.

(51) Int. Cl. G02B 5/28

(52) U.S. Cl. CPC G02B 5/286

(57) ABSTRACT

A multilayer structure that reflects color includes a core layer, and a conformal dielectric layer encapsulating the core layer. A conformal absorber layer encapsulates the conformal dielectric layer. The multilayer structure consists of three optical layers.

### CROSS-REFERENCE TO RELATED APPLICATION

This application claims the benefit of priority under 35 U.S.C. § 119 of U.S. Provisional Application Ser. No. 63/404,416 filed on Sep. 7, 2022, the content of which is relied upon and incorporated herein by reference in its entirety.

### FIELD

The present disclosure is related to multilayer structures, and in particular to multilayer structures comprising metal and metal oxide over a substrate, where at least one of the metal and metal oxide are deposited by atomic layer deposition.

### BACKGROUND

Pigments made from multilayer structures are known. In addition, pigments that exhibit or provide structural color are also known. However, such prior art pigments have required nine, eleven, or more thin film layers in order to obtain desired color properties.

It is appreciated that cost associated with the production of multilayer pigments is proportional to the number of layers required. As such, the cost associated with the production of structural colors using multilayer stacks of dielectric materials can be prohibitive. Therefore, a structural color that requires a minimum number of thin film layers would be desirable.

### SUMMARY

According to embodiments, a multilayer structure that reflects color comprises: a core layer; a conformal dielectric layer encapsulating the core layer; and a conformal absorber layer encapsulating the conformal dielectric layer, wherein the multilayer structure consists of three optical layers.

According to embodiments, as method for forming the multilayer structures comprise depositing the conformal dielectric layer onto the core layer by CVD or ALD; and depositing the conformal absorber layer onto the conformal dielectric layer by ALD.

Additional features and advantages will be set forth in the detailed description that follows, and in part will be readily apparent to those skilled in the art from that description or recognized by practicing the embodiments described herein, including the detailed description that follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 is a schematic cross section of a multilayer structure according to embodiments disclosed and described herein;

FIG. 2A depicts a multilayer structure with a dielectric layer extending over a core layer used in the design of a multilayer structure;

FIG. 2B depicts a multilayer structure with an absorber layer extending over a core layer used in the design of a multilayer structure;

FIG. 2C depicts a multilayer structure with a dielectric layer extending over a core layer used in the design of multilayer structure according to one or more embodiments shown and described herein;

FIG. 3 depicts reflectance properties of the multilayer structures illustrated in FIGS. 2A-2C on a Lab color space;

FIG. 4A graphically depicts chroma and hue values as a function of dielectric layer thickness for the multilayer structures illustrated in FIG. 2A;

FIG. 4B graphically depicts chroma and hue values as a function of semiconductor absorber layer thickness for the multilayer structure illustrated in FIG. 2B;

FIG. 4C graphically depicts chroma and hue values as a function of dielectric layer thickness for the multilayer structure illustrated in FIG. 2C;

FIG. 5 depicts a multilayer structure with a dielectric layer extending over a substrate layer and exposed to electromagnetic radiation at an angle θ relative to a normal direction to the outer surface of the dielectric layer;

FIG. 6A is a graph of reflectance versus wavelength of electromagnetic radiation that shows the effect of the thickness of a tungsten absorber layer; and

FIG. 6B is a graph of reflectance versus wavelength of electromagnetic radiation that shows the effect of the thickness of a TiO₂ dielectric layer.

### DETAILED DESCRIPTION

A structure that produces color is provided in this disclosure. The structure that produces color has the form of a multilayer structure that may reflect a narrow band of electromagnetic radiation in the visible spectrum and has a small or non-noticeable hue shift when the multilayer structure is viewed from angles between 0 to 45 degrees. The multilayer structure can be used as pigment in compositions (such as, for example, a paint composition), a film on a structure, and the like.

Preparing color multilayer structures can be a complex, expensive process because, in part, very tight control over layer thicknesses is required. The deposition methods used to deposit layers can vary in complexity and cost depending on the material that makes up a given layer and the desired thickness of the layer. Accordingly, different materials that make up a given layer and the desired thickness of the layer.

However, it can be challenging to deposit layers directly on a reflective core layer, such as an aluminum (Al) reflective core, and it can be difficult to deposit materials in layers having a nanoscale thicknesses. Atomic layer deposition (ALD) is one technique that is good at doing both, but ALD deposition has heretofore been costly and time consuming. For instance, ALD deposits material essentially on an atomic level, so it can take a large amount of time to deposit thick layers using an ALD process, such as layers having a thickness greater than 500 nm. Accordingly, ALD is typically not preferred for depositing every layer in a multilayer structure. Typically, because of the cost and time constraints, ALD has been reserved for depositing very thin layers, and layers applied by previous ALD methods created low quality layers that may have poor coverage or high porosity that make it difficult to apply additional high-quality metal and/or metal oxide layers to the multilayer structure.

However, as disclosed herein, it has been found that depositing all layers of a multilayer structure using ALD provides layers with properties—such as surface areas and pore volumes—that can allow a microlayer structure with three layers to perform in the same manner as multilayer structures with significantly more layers. Specifically, embodiments disclosed herein use ALD processes to deposit dense, non-porous metal and/or metal oxide layers to a reflector (such as Al). The quality of the layers deposited by ALD allows three-layer OSC multilayer structures that have optical properties that are similar to five- and seven-layered OSC multilayered structures. By decreasing the number of layers deposited to the multilayered structure, cost and time of manufacture can be decreased.

The multilayer structures described herein may be used to reflect wavelengths of visible light over a range of angles of incidence or viewing (such as hues between 0° and 120°). It will be understood that the terms “electromagnetic wave,” “electromagnetic radiation,” and “light,” as used herein, may interchangeably refer to various wavelengths of light incidence on a multilayer structure and that such light may have wavelengths in the ultraviolet (UV), infrared (IR), and visible portions of the electromagnetic spectrum.

As used herein, a “core layer” refers to a reflective core layer and a non-reflective core layer, and the “core layer” may have any shape including, but not limited to a flake, a sphere, an ovoid, and the like. As used herein, an “absorber layer” includes a metallic absorber layer and a non-metallic absorber layer.

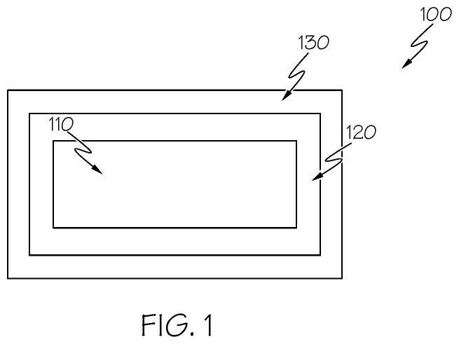

Referring now to FIG. 1, a multilayer structure 100 according to embodiments disclosed and described herein comprises a core layer 110, a conformal dielectric layer 120 that encapsulates the core layer 110, and a conformal absorber layer 130 that encapsulates the conformal dielectric layer 120. Multilayer structures 100 disclosed and described herein consist of three optical layers. These “optical layers” are layers that effect the optics of the multilayer structure 100, such as layers made from reflective materials, dielectric materials, and absorber materials where the layers are thick enough to affect the optics of the multilayer structure. The term “optical layers” as used herein does not include thin barrier layers that do not affect the optics of the multilayer structure.

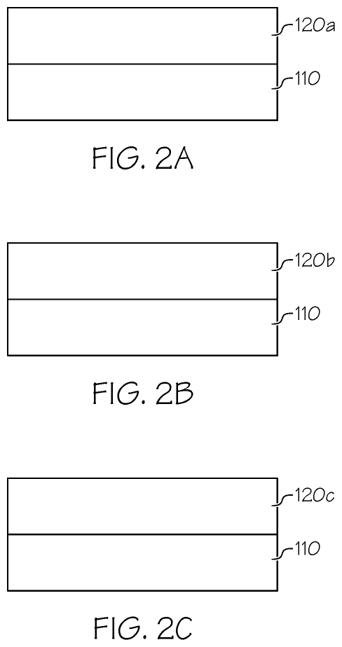

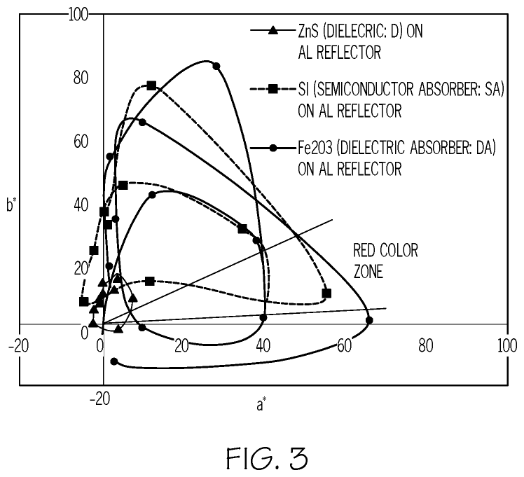

Referring to FIGS. 2A-2C and 3, the effectiveness of different types of layers extending across a core layer 110 in attaining a desired hue level in a desired region of the visible light spectrum as plotted or shown on a Lab color space is depicted. FIG. 2A depicts a ZnS dielectric layer 120a extending across a reflective core layer 110, FIG. 2B depicts a Si semiconductor absorber layer 120b extending across a reflective core layer 110, and FIG. 2C depicts a Fe₂O₃ dielectric layer 120c extending across a reflective core layer 110. Simulations of the reflectance from each multilayer structure illustrated in FIGS. 2A-2C are performed as a function of different thicknesses for the dielectric layer 120a, the semiconductor absorber layer 120b, and dielectric layer 120c. The results of the simulations are plotted on a Lab color space, also known as an a*b* color map, shown in FIG. 3. Each data point shown in FIG. 3 provides a chroma and a hue for particular thickness of the dielectric layer for the multilayer structure depicted in FIG. 2A, the semiconductor absorber layer for the multilayer structure depicted in FIG. 2B or the dielectric layer for the multilayer structure depicted in FIG. 2C. Chroma can be defined as C=\sqrt{(a*²+b*²)} and hue can be defined as tan⁻¹(a*/b*). The hue can also be referred to as the angle relative to the positive a*-axis of a given data point. A hue value provides a measure of the color displayed by an object (e.g., red, green, blue, yellow etc.), and a chroma value provides a measure of the color's “brightness.” As shown in FIG. 3, the multilayer structure illustrated in FIG. 2A provides low chroma compared to the multilayer structures illustrated in FIGS. 2B and 2C. Accordingly, FIGS. 2A-2C and FIG. 3 demonstrate that an absorber layer is preferred over a dielectric layer as a first layer extending over a reflective core layer when colors with high chroma are desired. It should be understood that the Lab color space analysis shown in FIG. 3 is for illustrative purposes and that multilayer structures according to embodiments disclosed and described herein may have different Lab color space values. For instance, in embodiments, the multilayer structures could exhibit a blue, green, yellow, or other colors in the Lab color space.

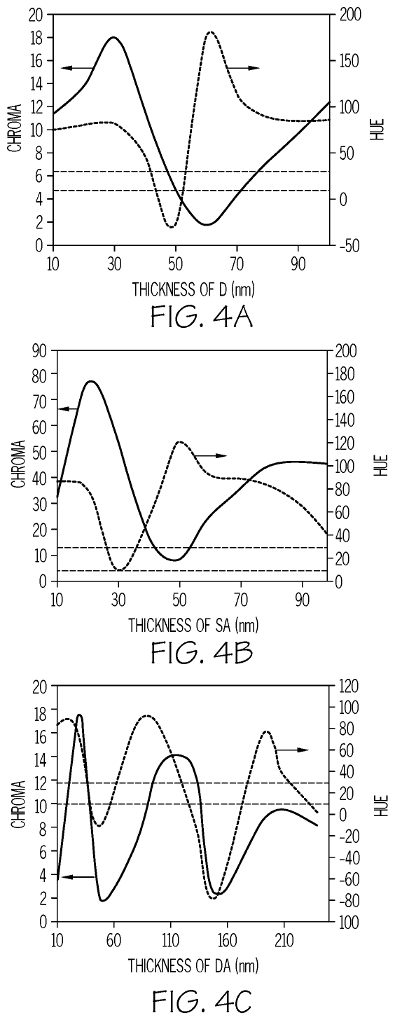

Referring to FIGS. 4A-4C, chroma and hue as a function of layer thickness is depicted. Specifically, FIG. 4A graphically depicts the chroma and hue as a function of the thickness of the ZnS dielectric layer extending over the Al reflective core layer illustrated in FIG. 2A. FIG. 4B depicts the chroma and hue as a function of the thickness of the Si semiconductor absorber layer extending over the Al reflective core layer illustrated in FIG. 2B. FIG. 4C depicts the chroma and hue as a function of the thickness of the Fe₂O₃ dielectric layer extending over the Al reflective core layer illustrated in FIG. 2C. The dotted lines in FIGS. 4A-4C correspond to desired hue values between 10° and 30° on the Lab color space. FIGS. 4A-4C illustrate that higher chroma values within the hue range between 10° and 30° are achieved for multilayer structures having a dielectric layer extending across the reflective core layer. Again, it should be understood that the hue and chroma shown in FIG. 4A-4C is for illustrative purposes and that multilayer structures according to embodiments disclosed and described herein may have different hue and chroma values.

Referring again to FIG. 1, a multilayer structure 100 that reflects a color according to embodiments is shown. The multilayer structure 100 includes a core layer 110, a conformal dielectric layer 120 encapsulating the core layer 110, and a conformal absorber layer 130 encapsulating the conformal dielectric layer 120. As shown in FIG. 1, embodiments of multilayer structures disclosed and described herein comprise a conformal dielectric layer 120 and a conformal absorber layer 130. As used herein, “conformal” is used to indicate that the layer conforms to the size and shape of the layer to which it is deposited and encapsulates (i.e., is present on all sides) of the layer to which it is deposited. Although FIG. 1 shows a rectangular structure, this is for illustrative purposes only, and often the multilayer structure will have an asymmetric and non-uniform shape. In embodiments, the multilayer structure may be spherical or ovoid. It should be understood that embodiments may also include a multilayer structure with a conformal absorber encapsulating the core layer, and a conformal dielectric layer encapsulating the conformal absorber layer.

In embodiments, the core layer 110 can have a thickness that is greater than or equal to 20 nm and less than or equal to 100 μm, such as greater than or equal to 50 nm and less than or equal to 80 μm, greater than or equal to 75 nm and less than or equal to 60 μm, greater than or equal to 100 nm and less than or equal to 40 μm, greater than or equal to 125 nm and less than or equal to 20 μm, or greater than or equal to 150 nm and less than or equal to 1 μm. The core layer 110 can, in embodiments, have a thickness between 50 nm and 10 μm, such as between 100 nm and 10 μm, between 250 nm and 10 μm, between 500 nm and 10 μm, between 750 nm and 10 μm, between 1 μm and 10 μm, between 2 μm and 10 μm, between 5 μm and 10 μm, between 8 μm and 10 μm, between 50 nm and 8 μm, between 100 nm and 8 μm, between 250 nm and 8 μm, between 500 nm and 8 μm, between 750 nm and 8 μm, between 1 μm and 8 μm, between 2 μm and 8 μm, between 5 μm and 8 μm, between 50 nm and 5 μm, between 100 nm and 5 μm, between 250 nm and 5 μm, between 500 nm and 5 μm, between 750 nm and 5 μm, between 1 μm and 5 μm, between 2 μm and 5 μm, between 50 nm and 2 μm, between 100 nm and 2 μm, between 250 nm and 2 μm, between 500 nm and 2 μm, between 750 nm and 2 μm, between 1 μm and 2 μm, between 50 nm and 1 μm, between 100 nm and 1 μm, between 250 nm and 1 μm, between 500 nm and 1 μm, between 750 nm and 1 μm, between 50 nm and 750 nm, between 100 nm and 750 nm, between 250 nm and 750 nm, between 500 nm and 750 nm, between 50 nm and 500 nm, between 100 nm and 500 nm, between 250 nm and 500 nm, between 50 nm and 250 nm, between 100 nm and 250 nm, or between 50 nm and 100 nm.

In embodiments, the core layer 110 can be made from at least one of a “gray metallic” material, such as Al, Ag, Pt, Sn; at least one of a “colorful metallic” material, such as Au, Cu, brass, bronze, TiN, Cr, stainless steel, or a combination thereof. In one or more embodiments, the core layer 110 can be made from an oxide, such as alumina (Al₂O₃), silica (SiO₂), or glass materials. The core layer 110 can have plate-like shape or can be spherical or ovoid, as mentioned above.

According to one or more embodiments, the conformal dielectric layer 120 has a thickness that is greater than or equal to 5 nm and less than or equal to 500 nm, such as greater than or equal to 10 nm and less than or equal to 475 nm, greater than or equal to 10 nm and less than or equal to 450 nm, greater than or equal to 10 nm and less than or equal to 425 nm, greater than or equal to 10 nm and less than or equal to 400 nm, greater than or equal to 10 nm and less than or equal to 375 nm, greater than or equal to 10 nm and less than or equal to 350 nm, greater than or equal to 10 nm and less than or equal to 325 nm, or greater than or equal to 10 nm and less than or equal to 300 nm. The conformal dielectric layer 120 can, according to embodiments, have a thickness between 5 nm and 300 nm, such as between 10 nm and 300 nm, between 15 nm and 300 nm, between 25 nm and 300 nm, between 50 nm and 300 nm, between 75 nm and 300 nm, between 100 nm and 300 nm, between 125 nm and 300 nm, between 150 nm and 300 nm, between 175 nm and 300 nm, between 200 nm and 300 nm, between 225 nm and 300 nm, between 250 nm and 300 nm, between 275 nm and 300 nm, between 5 nm and 275 nm, between 10 nm and 275 nm, between 15 nm and 275 nm, between 25 nm and 275 nm, between 50 nm and 275 nm, between 75 nm and 275 nm, between 100 nm and 275 nm, between 125 nm and 275 nm, between 150 nm and 275 nm, between 175 nm and 275 nm, between 200 nm and 275 nm, between 225 nm and 275 nm, between 250 nm and 275 nm, between 5 nm and 250 nm, between 10 nm and 250 nm, between 15 nm and 250 nm, between 25 nm and 250 nm, between 50 nm and 250 nm, between 75 nm and 250 nm, between 100 nm and 250 nm, between 125 nm and 250 nm, between 150 nm and 250 nm, between 175 nm and 250 nm, between 200 nm and 250 nm, between 225 nm and 250 nm, between 5 nm and 225 nm, between 10 nm and 225 nm, between 15 nm and 225 nm, between 25 nm and 225 nm, between 50 nm and 225 nm, between 75 nm and 225 nm, between 100 nm and 225 nm, between 125 nm and 225 nm, between 150 nm and 225 nm, between 175 nm and 225 nm, between 200 nm and 225 nm, between 5 nm and 200 nm, between 10 nm and 200 nm, between 15 nm and 200 nm, between 25 nm and 200 nm, between 50 nm and 200 nm, between 75 nm and 200 nm, between 100 nm and 200 nm, between 125 nm and 200 nm, between 150 nm and 200 nm, between 175 nm and 200 nm, between 5 nm and 175 nm, between 10 nm and 175 nm, between 15 nm and 175 nm, between 25 nm and 175 nm, between 50 nm and 175 nm, between 75 nm and 175 nm, between 100 nm and 175 nm, between 125 nm and 175 nm, between 150 nm and 175 nm, between 5 nm and 150 nm, between 10 nm and 150 nm, between 15 nm and 150 nm, between 25 nm and 150 nm, between 50 nm and 150 nm, between 75 nm and 150 nm, between 100 nm and 150 nm, between 125 nm and 150 nm, between 5 nm and 100 nm, between 10 nm and 100 nm, between 15 nm and 100 nm, between 25 nm and 100 nm, between 50 nm and 100 nm, between 75 nm and 100 nm, between 5 nm and 75 nm, between 10 nm and 75 nm, between 15 nm and 75 nm, between 25 nm and 75 nm, between 50 nm and 75 nm, between 5 nm and 50 nm, between 10 nm and 50 nm, between 15 nm and 50 nm, between 25 nm and 50 nm, between 5 nm and 25 nm, between 10 nm and 25 nm, between 15 nm and 25 nm, between 5 nm and 15 nm, between 10 nm and 15 nm, or between 5 nm and 10 nm.

The conformal dielectric layer 120 is, in embodiments, a high refractive index material, such as TiO₂ (including anatase, rutile, or amorphous TiO₂ and mixtures thereof), ZnS, ZrO₂, HfO₂, Fe₃O₄, or AlAs. In one or more embodiments, the conformal dielectric layer 120 may be made from high refractive index absorptive dielectric materials such as Fe₂O₃, PbS, GaAs, or InAs. In embodiments, the conformal dielectric layer may be made from a low refractive index material, such as SiO₂, MgF₂, KBr, ZnO, or Al₂O₃. The conformal dielectric layer 120 can, in embodiments, be deposited to encapsulate the core layer 110 by CVD, PVD, wet chemical methods, or ALD.

As shown in FIG. 1, a conformal absorber layer 130 encapsulates the conformal dielectric layer 120. The location of the conformal absorber layer 130 is chosen to increase the absorption of target light wavelengths. For instance, if the multilayer structure is to be configured to absorb electromagnetic radiation having wavelengths that are less than or equal to 550 nm but reflect electromagnetic radiation with wavelengths of approximately 650 nm, such as visible light outside of the hue between 10° and 30°, the absorber layer is placed at a thickness where the electric field (|E|²) is less at the 550 nm wavelength than at the 650 nm wavelength. Mathematically, this can be expressed as:

|E₅₅₀|²<<|E₆₅₀|² (1)
and preferably:

|E₆₅₀|²≈0 (2)

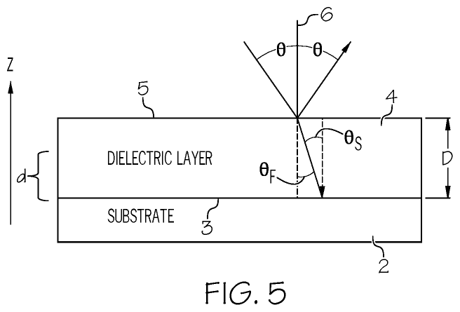

FIG. 5 and the following discussion provide a method for calculating the thickness of a zero or near-zero electric field point at a given wavelength of light, according to embodiments. For the purposes of the present specification, the term “near-zero” is defined |E|²≤10. FIG. 5 illustrates a multilayer structure with a dielectric layer 4 having a total thickness “D”, an incremental thickness “d” and an index of refraction “n” on a substrate layer 2 having an index of refraction “nₛ”. The substrate layer 2 can be a core layer or a reflective core layer of a multilayer structure. Incident light strikes the outer surface 5 of the dielectric layer 4 at angle θ relative to line 6, which is perpendicular to the outer surface 5, and reflects from the outer surface 5 at the same angle θ. Incident light is transmitted through the outer surface 5 and into the dielectric layer 4 at an angle θ_{F} relative to the line 6 and strikes the surface 3 of substrate layer 2 at an angle θₛ. For a single dielectric layer, θₛ=θ_{F} and the energy/electric field (E) can be expressed as E(z) when z=d. From Maxwell's equations, the electric field can be expressed for s polarization as:

\vec{E}(d)={u(z), 0, 0}exp(ikαy)|_{z=d} (3)
and for p polarization as:

$$\vec{E} ( d ) = \{ 0 , u ( z ) , - \frac{α}{\tilde{ε} ( z )} v ( z ) \} exp ( ik α y ) {\vert}_{z = d} \qquad ( 4 )$$

where

$$k = \frac{2 π}{λ} , λ$$

is a desired wavelength to be reflected, α=nₛ sin θₛ where “s” corresponds to the substrate in FIG. 7, and \tilde{ε}(z) is the permittivity of the layer as a function of z. As such:

|E(d)|²=|u(z)|² exp(2ikαy)|_{z=d} (5)
for s polarization, and

$${{\vert E ( d ) \vert}^{2} = [ {\vert u ( z ) \vert}^{2} + {\vert \frac{α}{\sqrt{n}} v ( z ) \vert}^{2} ] exp ( 2 ik α y ) \vert}_{z = d} \qquad ( 6 )$$

for p polarization.

It should be appreciated that variation of the electric field along the Z direction of the dielectric layer 4 can be estimated by calculation of the unknown parameters u(z) and v(z), where it can be shown that:

$${( \begin{matrix}u \\ v\end{matrix} )}_{z = d} = ( \begin{matrix}cos φ & ( i / q ) sin φ \\ iq sin φ & cos φ\end{matrix} ) {( \begin{matrix}u \\ v\end{matrix} )}_{z = 0 , substrate} \qquad ( 7 )$$

where ‘i’ is the square root of −1. Using the boundary conditions u|_{z=0}=1, v|_{z=0}=qₛ, and the following relations:

qₛ=nₛ cos θₛ for s-polarization (8)

qₛ=nₛ/cos θₛ for p-polarization (9)

q=n cos θ_{F} for s-polarization (10)

q=n/cos θ_{F} for p-polarization (11)

φ=k·n·d cos(θ_{F}) (12)
u(z) and v(z) can be expressed as:

$$\begin{matrix}u ( z ) {\vert}_{z = d} = u {\vert}_{z = 0} cos φ + v {\vert}_{z = o} ( \frac{1}{q} sin φ ) \\ = cos φ + \frac{i . {q}_{s}}{q} sin φ\end{matrix} \qquad ( 13 )$$

$$and$$

$$\begin{matrix}v ( z ) {\vert}_{z = d} = iqu {\vert}_{z = 0} sin φ + v {\vert}_{z = 0} cos φ \\ = iq sin φ + {q}_{s} cos φ\end{matrix} \qquad ( 14 )$$

Therefore:

$$\begin{matrix}{\vert E ( d ) \vert}^{2} = [ {cos}^{2} φ + \frac{{q}_{s}^{2}}{{q}^{2}} {sin}^{2} φ ] {e}^{2 ik αγ} \\ = [ {cos}^{2} φ + \frac{{n}_{s}^{2}}{{n}^{2}} {sin}^{2} φ ] {e}^{2 ik a γ}\end{matrix} \qquad ( 15 )$$

for s polarization with φ=k·n·d cos(θ_{F}), and:

$$\begin{matrix}{\vert E ( d ) \vert}^{2} = [ {cos}^{2} φ + \frac{{n}_{s}^{2}}{{n}^{2}} {sin}^{2} φ + \frac{{α}^{2}}{n} ( {q}_{s}^{2} {cos}^{2} φ + {q}^{2} {sin}^{2} φ ) ] \\ = [ ( 1 + \frac{{α}^{2} {q}_{s}^{2}}{n} ) {cos}^{2} φ + ( \frac{{n}_{s}^{2}}{{n}^{2}} + \frac{{α}^{2} {q}^{2}}{n} ) {sin}^{2} φ ]\end{matrix} \qquad ( 16 )$$

for p polarization where:

$$α = {n}_{s} sin {θ}_{s} = n sin {θ}_{F} \qquad ( 17 )$$

$${q}_{s} = \frac{{n}_{s}}{cos {θ}_{s}} \qquad ( 18 )$$

$$and$$

$${q}_{s} = \frac{n}{cos {θ}_{F}} \qquad ( 19 )$$

Thus for a simple situation where θ_{F}=0 or normal incidence, φ=k·n·d, and α=0:

$${\vert E ( d ) \vert}^{2} for s - polarization = {\vert E ( d ) \vert}^{2} for p - polarization = [ {cos}^{2} φ + \frac{{n}_{s}^{2}}{{n}^{2}} {sin}^{2} φ ] \qquad ( 20 )$$

$$= [ {cos}^{2} ( k \cdot n \cdot d ) + \frac{{n}_{s}^{2}}{{n}^{2}} {sin}^{2} ( k \cdot n \cdot d ) ] \qquad ( 21 )$$

which allows for the thickness “d” to be solved for (i.e., the position or location within the dielectric layer where the electric field is zero). It should be appreciated that the thickness “d” can be the thickness of the conformal dielectric layer 120 extending over the core layer 110 that provides a zero or near zero electric field at the interface between the conformal dielectric layer 120 and the conformal absorber layer 130. It should also be appreciated that the thickness “d” can also be the thickness of the dielectric outer layer 140 extending over the conformal absorber layer 130 that provides a zero or near zero electric field at the interface between the dielectric outer layer and the conformal absorber layer 130, depending on the thickness “d” where the electric field is zero or near-zero.

In embodiments, the conformal absorber layer has a thickness that is from greater than or equal to 2 nm and less than or equal to 50 nm, such as greater than or equal to 2 nm and less than or equal to 45 nm, greater than or equal to 2 nm and less than or equal to 40 nm, greater than or equal to 2 nm and less than or equal to 35 nm, greater than or equal to 2 nm and less than or equal to 30 nm, or greater than or equal to 2 nm and less than or equal to 25 nm. The conformal absorber layer 130 can, in embodiments, have a thickness between 2 nm and 20 nm, such as between 5 nm and 20 nm, between 8 nm and 20 nm, between 10 nm and 20 nm, between 12 nm and 20 nm, between 15 nm and 20 nm, between 18 nm and 20 nm, between 2 nm and 18 nm, between 5 nm and 18 nm, between 8 nm and 18 nm, between 10 nm and 18 nm, between 12 nm and 18 nm, between 15 nm and 18 nm, between 2 nm and 15 nm, between 5 nm and 15 nm, between 8 nm and 15 nm, between 10 nm and 15 nm, between 12 nm and 15 nm, between 2 nm and 12 nm, between 5 nm and 12 nm, between 8 nm and 12 nm, between 10 nm and 12 nm, between 2 nm and 10 nm, between 5 nm and 10 nm, between 8 nm and 10 nm, between 2 nm and 8 nm, between 5 nm and 8 nm, or between 2 nm and 5 nm.

In embodiments, the conformal absorber layer 130 can be made from at least a material selected from W, Cr, Ge, Ni, stainless steel, Pd, Ti, Si, V, TiN, Co, Mo, Nb, ferric oxide, or combinations thereof. In one or more embodiments, the conformal absorber layer 130 is comprised of W. In embodiments, ALD is used to deposit the conformal absorber layer 130 because ALD allows uniform deposition of materials at the thicknesses desired. Other deposition methods have difficulty depositing uniform layers at thicknesses of 20 nm and below.

In one or more embodiments, each of the core layer 110, the first conformal dielectric layer 120, the conformal absorber layer 130, and the second conformal dielectric layer 140 individually has a pore volume that is less than or equal to 0.030 cm³/g, such as less than or equal to 0.025 cm³/g, less than or equal to 0.020 cm³/g, or less than or equal to 0.015 cm³/g. In embodiments, each of the core layer 110, the conformal dielectric layer 120, and the conformal absorber layer 130, individually has a pore volume that is less than or equal to 0.010 cm³/g, such as less than or equal to 0.009 cm³/g, less than or equal to 0.008 cm³/g, less than or equal to 0.007 cm³/g, less than or equal to 0.006 cm³/g, less than or equal to 0.005 cm³/g pore volume, less than or equal to 0.004 cm³/g, less than or equal to 0.003 cm³/g, less than or equal to 0.002 cm³/g, less than or equal to 0.001 cm³/g. It should be understood that in embodiments one or more of the core layer 110, the conformal dielectric layer 120, and the conformal absorber layer 130, may have the same pore volume and in other embodiments one or more of the core layer 110, the conformal dielectric layer 120, and the conformal absorber layer 130 may have different pore volume.

In one or more embodiments the surface area of the each of the core layer 110, the first conformal dielectric layer 120, the conformal absorber layer 130, and the second conformal dielectric layer 140 individually is less than or equal to 100 square meters per gram (m²/g), such as less than or equal to 90 m²/g, less than or equal to 85 m²/g, less than or equal to 80 m²/g, less than or equal to 75 m²/g, less than or equal to 70 m²/g, less than or equal to 65 m²/g, less than or equal to 60 m²/g, less than or equal to 55 m²/g, less than or equal to 50 m²/g, less than or equal to 45 m²/g, less than or equal to 40 m²/g, less than or equal to 35 m²/g, less than or equal to 30 m²/g, less than or equal to 25 m²/g, less than or equal to 20 m²/g, or less than or equal to 15 m²/g. The surface area, in embodiments, of the each of the core layer 110, the conformal dielectric layer 120, and the conformal absorber layer 130 individually is less than or equal to 10 m²/g, such as less than or equal to 9 m²/g, less than or equal to 8 m²/g, less than or equal to 7 m²/g, less than or equal to 6 m²/g, less than or equal to 5 m²/g, less than or equal to 4 m²/g, less than or equal to 3 m²/g, less than or equal to 2 m²/g, or less than or equal to 1 m²/g. Accordingly, in embodiments, each of the layers may individually have a surface area from 2 m²/g to 10 m²/g, from 3 m²/g to 10 m²/g, from 3 m²/g to 8 m²/g, from 5 m²/g to 8 m²/g, from 1 m²/g to 3 m²/g, from 3 m²/g to 5 m²/g, from 2 m²/g to 3 m²/g, from 1 m²/g to 2 m²/g, or from 0.5 m²/g to 1 m²/g. The surface area is measured by collecting full adsorption/desorption isotherms over samples, after degassing at 90° C. for one hour, and degassing to 150° C. for three hours. It should be understood that in embodiments one or more of the core layer 110, the conformal dielectric layer 120, and the conformal absorber layer 130 may have the same surface area and in other embodiments one or more of the core layer 110, the conformal dielectric layer 120, and the conformal absorber layer 130 may have different surface areas.

The isotherms were collected using nitrogen physisorption at 76 K to obtain the specific surface area (SSA) of the materials, by fitting 13 points collected from P/P₀≈0.06-0.3 to the Brunauer-Emmett-Teller (BET) equation. Additional adsorption points were collected at various P/P₀, up to P/P₀≈0.95, followed by desorption back to P/P₀≈0.06. The total pore volume was determined by the volume of nitrogen adsorbed at P/P₀ 0.95, and average pore diameter was calculated using the Barrett Joyner Halenda (BJH) method.

In embodiments, the multilayer structure may have a D₅₀ diameter measured by the BET equation the amount of adsorbed gas, which build up one monolayer on the surface, can be calculated from the measured isotherm. The amount of molecules in this monolayer multiplied by the required space of one molecule gives the BET D₅₀ that is from 1 μm to 500 μm, such as from 10 μm to 500 μm, from 20 μm to 500 μm, from 25 μm to 500 μm, from 50 μm to 500 μm, from 100 μm to 500 μm, from 150 μm to 500 μm, from 200 μm to 500 μm, from 250 μm to 500 μm, from 300 μm to 500 μm, from 350 μm to 500 μm, from 400 μm to 500 μm, from 450 μm to 500 μm, from 5 μm to 450 μm, from 10 μm to 450 μm, from 20 μm to 450 μm, from 25 μm to 450 μm, from 50 μm to 450 μm, from 100 μm to 450 μm, from 150 μm to 450 μm, from 200 μm to 450 μm, from 250 μm to 450 μm, from 300 μm to 450 μm, from 350 μm to 450 μm, from 400 μm to 450 μm, from 5 μm to 400 μm, from 10 μm to 400 μm, from 20 μm to 400 μm, from 25 μm to 400 μm, from 50 μm to 400 μm, from 100 μm to 400 μm, from 150 μm to 400 μm, from 200 μm to 400 μm, from 250 μm to 400 μm, from 300 μm to 400 μm, from 350 μm to 400 μm, from 5 μm to 350 μm, from 10 μm to 350 μm, from 20 μm to 350 μm, from 25 μm to 350 μm, from 50 μm to 350 μm, from 100 μm to 350 μm, from 150 μm to 350 μm, from 200 μm to 350 μm, from 250 μm to 350 μm, from 300 μm to 350 μm, from 5 μm to 300 μm, from 10 μm to 300 μm, from 20 μm to 300 μm, from 25 μm to 300 μm, from 50 μm to 300 μm, from 100 μm to 300 μm, from 150 μm to 300 μm, from 200 μm to 300 μm, from 250 μm to 300 μm, from 5 μm to 250 μm, from 10 μm to 250 μm, from 20 μm to 250 μm, from 25 μm to 250 μm, from 50 μm to 250 μm, from 100 μm to 250 μm, from 150 μm to 250 μm, from 200 μm to 250 μm, from 5 μm to 200 μm, from 10 μm to 200 μm, from 20 μm to 200 μm, from 25 μm to 200 μm, from 50 μm to 200 μm, from 100 μm to 200 μm, from 150 μm to 200 μm, from 5 μm to 150 μm, from 10 μm to 150 μm, from 20 μm to 150 μm, from 25 μm to 150 μm, from 50 μm to 150 μm, from 100 μm to 150 μm, from 5 μm to 100 μm, from 10 μm to 100 μm, from 20 μm to 100 μm, from 25 μm to 100 μm, from 50 μm to 100 μm, from 5 μm to 50 μm, from 10 μm to 50 μm, from 20 μm to 50 μm, from 25 μm to 50 μm, from 5 μm to 25 μm, from 10 μm to 25 μm, from 20 μm to 25 μm, from 5 μm to 20 μm, from 10 μm to 20 μm, or from 5 μm to 10 μm.

The aspect ratio of the multilayer structures according to embodiments disclosed and described herein is from 1 to 100 as measure by electron microscope (TEM, SEM), with both cross-section and surface being measured, based on a large population of flakes, such as from 5 to 100, from 10 to 100, from 20 to 100, from 30 to 100, from 40 to 100, from 50 to 100, from 60 to 100, from 70 to 100, from 80 to 100, from 90 to 100, from 5 to 90, from 10 to 90, from 20 to 90, from 30 to 90, from 40 to 90, from 50 to 90, from 60 to 90, from 70 to 90, from 80 to 90, from 5 to 80, from 10 to 80, from 20 to 80, from 30 to 80, from 40 to 80, from 50 to 80, from 60 to 80, from 70 to 80, from 5 to 70, from 10 to 70, from 20 to 70, from 30 to 70, from 40 to 70, from 50 to 70, from 60 to 70, from 5 to 60, from 10 to 60, from 20 to 60, from 30 to 60, from 40 to 60, from 50 to 60, from 5 to 50, from 10 to 50, from 20 to 50, from 30 to 50, from 40 to 50, from 5 to 40, from 10 to 40, from 20 to 40, from 30 to 40, from 10 to 40, from 20 to 40, from 30 to 40, from 5 to 30, from 10 to 30, from 20 to 30, from 5 to 20, from 10 to 20, or from 5 to 10.

Embodiments of the multilayer structure 100 described above have a hue shift of less than 30°, such as less than 25°, less than 20°, less than 15°, or less than 10° in the Lab color space when viewed at angles from 0° to 45°.

In one or more embodiments, the multilayer structure 100 comprises a reflective core layer 110 made from Al, a conformal dielectric layer 120 deposited by ALD and made from TiO₂ encapsulating the reflective core layer 110, and a conformal metallic absorber layer 130 deposited by ALD and made from W encapsulating the conformal dielectric layer 120.

In one or more embodiments, the multilayer structure 100 comprises a reflective core layer 110 made from Al, a conformal dielectric layer 120 deposited by ALD and made from Fe₂O₃ encapsulating the reflective core layer 110, and a conformal metallic absorber layer 130 deposited by ALD and made from W encapsulating the conformal dielectric layer 120.

The multilayer structures in embodiments disclosed herein can be used as pigments (e.g., paint pigments for a paint used to paint an object), or a continuous structure applied to an object. When used as pigments, at least one of paint binders and fillers can be used and mixed with the pigments to provide a paint that displays an omnidirectional structural color. In addition, other additives may be added to the multilayer structure to aid the compatibility of multilayer structure in the paint system. Exemplary compatibility-enhancing additives include silane surface treatments that coat the exterior of the multilayer structure and improve the compatibility of multilayer structure in the paint system. Such paint systems or films can be used on any article, including an automotive vehicle.

As mentioned herein at least one of the metal or metal oxide layer (such as the conformal dielectric layer and the conformal absorber layer) may be deposited by ALD. Embodiments of ALD processes for depositing these layers will be discussed in more detail below.

In addition, using an ALD process allows the deposition of multiple layers with optical precision and a vast difference in material properties (such as dielectric materials vs. metallic materials as described above) at a large scale. Moreover, ALD processes allow for production of multilayer structures with high density, low porosity, and complete layer coverage all with nanometer-scale precision. And, the deposition precision and non-destructive features of ALD have little impact on the existing vulnerable layer(s) (e.g., an Al core layer and the like). Such results are difficult or costly to achieve in other processes.

A first aspect includes, a multilayer structure that reflects color comprising: a core layer; a conformal dielectric layer encapsulating the core layer; and a conformal absorber layer encapsulating the conformal dielectric layer, wherein the multilayer structure consists of three optical layers.

A second aspect includes, a multilayer structure according to the first aspect, wherein the multilayer structure reflects a single narrow band of visible light when exposed to broadband electromagnetic radiation, the single narrow band of visible light comprising: a color shift of the single narrow band of visible light is less than 30° measured in Lab color space when the multilayer structure is exposed to broadband electromagnetic radiation and viewed from angles between 0° and 45° relative to a direction normal to an outer surface of the multilayer structure.

A third aspect includes a multilayer structure of the first or second aspect, wherein the core layer is formed from Al, Ag, Pt, Sn, Au, Cu, brass, bronze, stainless steel, TiN, Cr, Al₂O₃, SiO₂, glass or combinations thereof.

A fourth aspect includes a multilayer structure according to the first to third aspects, wherein the core layer has a thickness between 20 nm and 100 μm.

A fifth aspect includes a multilayer structure according to the first to fourth aspects, wherein the conformal dielectric layer is formed from TiO₂, ZnS, ZrO₂, HfO₂, Fe₃O₄, AlAs, Fe₂O₃, PbS, GaAs, InAs, SiO₂, MgF₂, KBr, ZnO, Al₂O₃, and combinations thereof.

A sixth aspect includes a multilayer structure according to the first to fifth aspects, wherein the conformal dielectric layer has a thickness between 5 nm and 500 nm.

A seventh aspect includes a multilayer structure according to the first to sixth aspects, wherein the conformal absorber layer is formed from W, Cr, Ge, Ni, stainless steel, Pd, Ti, Si, V, TiN, Co, Mo, Nb, ferric oxide, or combinations thereof.

An eighth aspect includes a multilayer structure according to the first to seventh aspects, wherein the conformal absorber layer has a thickness between 2 nm and 50 nm.

A ninth aspect includes a multilayer structure according to the first to eighth aspects, wherein the core layer is formed from Al, the conformal dielectric layer is formed from TiO₂, and the conformal absorber layer is formed from W.

A tenth aspect includes a multilayer structure according to the first to eighth aspects, wherein the core layer is formed from Al, the conformal dielectric layer is formed from Fe₂O₃, and the conformal absorber layer is formed from W.

An eleventh aspect includes a multilayer structure according to the first to tenth aspects, wherein each of the core layer, the conformal dielectric layer, and the conformal absorber layer individually has a pore volume that is less than or equal to 0.030 cm³/g.

A twelfth aspect includes a multilayer structure according to the first to eleventh aspects, wherein each of the core layer, the conformal dielectric layer, and the conformal absorber layer individually has a pore volume that is less than or equal to 0.005 cm³/g.

A thirteenth aspect includes a multilayer structure according to the first to twelfth aspects, wherein each of the core layer, the conformal dielectric layer, and the conformal absorber layer individually has a surface area less than or equal to 100 m²/g.

A fourteenth aspect includes a multilayer structure according to the first to thirteenth aspects, wherein each of the core layer, the conformal dielectric layer, and the conformal absorber layer individually has a surface area less than or equal to 5 m²/g.

A fifteenth aspect includes a multilayer structure according to the first to fourteenth aspects, wherein the multilayer structure has a D₅₀ diameter that is from 1 μm to 500 μm.

A sixteenth aspect includes a multilayer structure according to the first to fifteenth aspects, wherein the multilayer structure has an aspect ratio from 1 to 100.

A seventeenth aspect a method for forming the multilayer structure of first to sixteenth aspects, the method comprising: depositing the conformal dielectric layer onto the core layer by CVD or ALD; and depositing the conformal absorber layer onto the conformal dielectric layer by ALD.

An eighteenth aspect includes a method for forming the multilayer structure of the first to sixteenth aspects, the method comprising: depositing the conformal dielectric layer onto the core layer by ALD; and depositing the conformal absorber layer onto the conformal dielectric layer by ALD.

A nineteenth aspect includes a paint system comprising: a binder; and a multilayer structure of any of the first to sixteenth aspects.

A twentieth aspect includes an automotive vehicle comprising the paint system of the nineteenth aspect.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

### EXAMPLES

Embodiments will be further clarified by the following examples.

### Example 1

Multilayer structures formed by an ALD process deposit distinct and deposited as smooth layers for each layer in the three-layer multilayer structure.

### Example 2

A comparison of a TiO₂ dielectric layer deposited by the ALD process of Example 1 is compared to a TiO₂ dielectric layer formed by wet chemical processes.

The pigments were suspended in isopropyl alcohol (IPA) in a flask at 40° C. A solution of titanium ethoxide dissolved in IPA was titrated at constant rate for 2.5 hours. At the same time, DI water diluted in IPA is metered in. After the titration, the suspension was stirred for another 30 minutes. The mixture was allowed to cool to room temperature, then filtered off, washed with IPA and dried at 100° C. for 24 hours. Then the collected product was allowed to sinter at 300-500° C. for a period of 2-6 hours.

The dielectric layer deposited by the ALD process of Example 1 was much more smooth and dense than the dielectric layer formed by wet chemical methods.

### Example 3

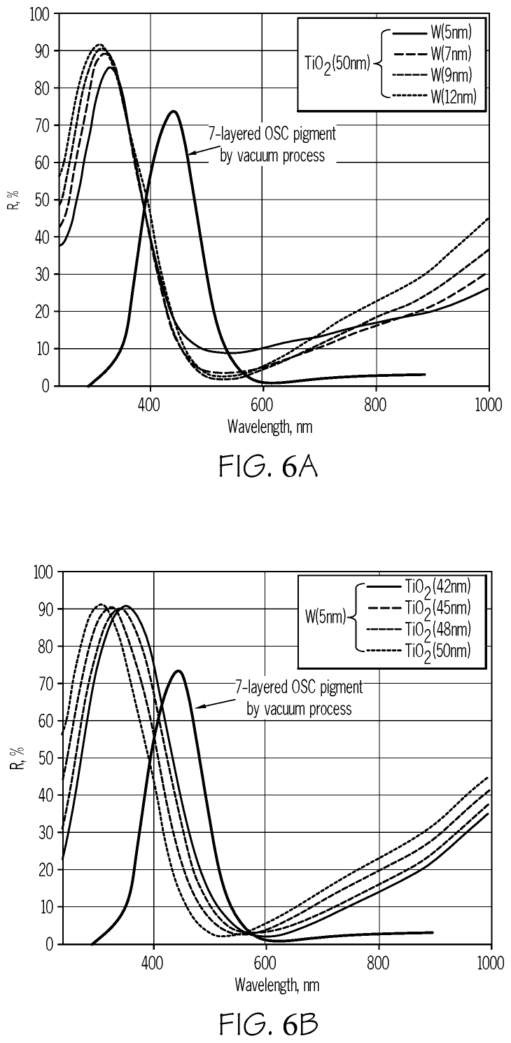

The effects of the thicknesses for tungsten metallic absorber layers and TiO₂ dielectric layers were studied in this example. FIG. 6A shows four samples made according to the ALD process of Example 1, except that the process was modified to provide tungsten metallic absorber layers with thickness of 5 nm, 7 nm, 9 nm, and 12 nm. All of these samples had an Al reflective core layer and a 50 nm thick TiO₂ dielectric layer. As shown in FIG. 6A, as the thickness of the tungsten layer increased, the reflectance curve shifted slightly to the left (lower wavelengths) and became more reflective.

FIG. 6B shows four samples made according to the ALD process of Example 1, except that the process was modified to provide TiO₂ dielectric layers with thickness of 42 nm, 45 nm, 48 nm, and 50 nm. All of these samples had an Al reflective core layer and a 5 nm thick tungsten metallic absorber layer. As shown in FIG. 6B, as the thickness of the titanium dioxide layer increased, the reflectance curve shifted slightly to the left (lower wavelengths). However, each of the samples performed significantly better than a seven layer structure formed by vacuum deposition.

### Example 4

This example compares the density, surface area, and pore volumes of multilayer structures made according to the ALD process of Example 1 and a wet chemical method as described in Example 2. As shown in Table 1 below, the density of the multilayer structures made by the ALD and wet chemical methods were the same, but surface area of the multilayer structure was much smaller using the ALD method.

TABLE 1

| | | |
|---|---|---|
| Property | ALD Method | Wet Chem. Method |

| | | | | |
|---|---|---|---|---|
| Density | 2.8 | g/cm³ | 2.8 | g/cm³ |
| Surface Area (BET) | 3.6 | m²/g | 109.2 | m²/g |
| Pore Volume (BET) | 0.005 | cm³/g | 0.036 | cm³/g |

The density of the pigment is the ratio of the mass of the pigment sample and its volume including the contribution of the interparticulate void volume. To measure this, a glass cylinder with specific volume was used and known mass of pigments were introduced into the cylinder. The volume was estimated by addition of DI water into the cylinder until the water reach the volume line of cylinder. By measuring the weight of how much DI water was added, the volume of water was obtained. The sample volume was obtained by subtracting the volume of water with total volume of cylinder. Replicate experiments were performed for the determination of the density. Full adsorption/desorption isotherms were collected over samples, after degassing at 90° C. for one hour, and then degassing at 150° C. for three hours. The isotherms were collected using nitrogen physisorption at 76 K to obtain the specific surface area (SSA) of the materials, by fitting 13 points collected from P/P₀≈0.06-0.3 to the Brunauer-Emmett-Teller (BET) equation. Additional adsorption points were collected at various P/P₀, up to P/P₀≈0.95, followed by desorption back to P/P₀≈0.06. The total pore volume was determined by the volume of nitrogen adsorbed at P/P₀ 0.95, and average pore diameter was calculated using the Barrett Joyner Halenda (BJH) method.

It will be apparent to those skilled in the art that various modifications and variations can be made to the embodiments described herein without departing from the spirit and scope of the claimed subject matter. Thus, it is intended that the specification cover the modifications and variations of the various embodiments described herein provided such modification and variations come within the scope of the appended claims and their equivalents.

What is claimed is:

1. A multilayer structure that reflects color comprising:
a core layer;
a conformal dielectric layer encapsulating the core layer; and
a conformal absorber layer encapsulating the conformal dielectric layer, wherein
the multilayer structure consists of three optical layers.

2. The multilayer structure of claim 1, wherein the multilayer structure reflects a single narrow band of visible light when exposed to broadband electromagnetic radiation, the single narrow band of visible light comprising:
a color shift of the single narrow band of visible light is less than 30° measured in Lab color space when the multilayer structure is exposed to broadband electromagnetic radiation and viewed from angles between 0° and 45° relative to a direction normal to an outer surface of the multilayer structure.

3. The multilayer structure of claim 1, wherein the core layer is formed from Al, Ag, Pt, Sn, Au, Cu, brass, bronze, stainless steel, TiN, Cr, Al₂O₃, SiO₂, glass or combinations thereof.

4. The multilayer structure of claim 1, wherein the core layer has a thickness between 20 nm and 100 μm.

5. The multilayer structure of claim 1, wherein the conformal dielectric layer is formed from TiO₂, ZnS, ZrO₂, HfO₂, Fe₃O₄, AlAs, Fe₂O₃, PbS, GaAs, InAs, SiO₂, MgF₂, KBr, ZnO, Al₂O₃, and combinations thereof.

6. The multilayer structure of claim 1, wherein the conformal dielectric layer has a thickness between 5 nm and 500 nm.

7. The multilayer structure of claim 1, wherein the conformal absorber layer is formed from W, Cr, Ge, Ni, stainless steel, Pd, Ti, Si, V, TiN, Co, Mo, Nb, ferric oxide, or combinations thereof.

8. The multilayer structure of claim 1, wherein the conformal absorber layer has a thickness between 2 nm and 50 nm.

9. The multilayer structure of claim 1, wherein
the core layer is formed from Al,
the conformal dielectric layer is formed from TiO₂, and
the conformal absorber layer is formed from W.

10. The multilayer structure of claim 1, wherein
the core layer is formed from Al,
the conformal dielectric layer is formed from Fe₂O₃, and
the conformal absorber layer is formed from W.

11. The multilayer structure of claim 1, wherein each of the core layer, the conformal dielectric layer, and the conformal absorber layer individually has a pore volume that is less than or equal to 0.030 cm³/g.

12. The multilayer structure of claim 1, wherein each of the core layer, the conformal dielectric layer, and the conformal absorber layer individually has a pore volume that is less than or equal to 0.005 cm³/g.

13. The multilayer structure of claim 1, wherein each of the core layer, the conformal dielectric layer, and the conformal absorber layer individually has a surface area less than or equal to 100 m²/g.

14. The multilayer structure of claim 1, wherein each of the core layer, the conformal dielectric layer, and the conformal absorber layer individually has a surface area less than or equal to 5 m²/g.

15. The multilayer structure of claim 1, wherein the multilayer structure has a D₅₀ diameter that is from 1 μm to 500 μm.

16. The multilayer structure of claim 1, wherein the multilayer structure has an aspect ratio from 1 to 100.

17. A method for forming the multilayer structure of claim 1, the method comprising:
depositing the conformal dielectric layer onto the core layer by CVD or ALD; and
depositing the conformal absorber layer onto the conformal dielectric layer by ALD.

18. A method for forming the multilayer structure of claim 1, the method comprising:
depositing the conformal dielectric layer onto the core layer by ALD; and
depositing the conformal absorber layer onto the conformal dielectric layer by ALD.

19. A paint system comprising:
a binder; and
a multilayer structure of claim 1.

20. An automotive vehicle comprising the paint system of claim 19.
